(19) United States
(12) Patent Application Publication
(10) Pub. No.: US 2022/0003893 A1
(43) Pub. Date: Jan. 6, 2022

(54) FORECAST OPERATION METHOD FOR LOWERING RESERVOIR FLOOD LIMITED WATER LEVEL CONSIDERING FORECAST UNCERTAINTY

(71) Applicant: DALIAN UNIVERSITY OF TECHNOLOGY, Dalian, Liaoning (CN)

(72) Inventors: Wei DING, Dalian, Liaoning (CN); Guozhen WEI, Dalian, Liaoning (CN); Guohua LIANG, Dalian, Liaoning (CN); Chi ZHANG, Dalian, Liaoning (CN); Jian WU, Dalian, Liaoning (CN); Huicheng ZHOU, Dalian, Liaoning (CN)

(21) Appl. No.: 17/278,595

(22) PCT Filed: Jul. 24, 2020
(86) PCT No.: PCT/CN2020/104493

§ 371 Date: Mar. 22, 2021

(30) Foreign Application Priority Data
Oct. 16, 2019 (CN) 201910982511.0

(51) Int. Cl. G01W 1/10; G05B 17/02; G06Q 10/04; G06Q 10/06; G06Q 50/26

(52) U.S. Cl. CPC G01W 1/10; G05B 17/02; G06Q 50/26; G06Q 10/0635; G06Q 10/04

(57) ABSTRACT

A forecast operation method for lowering the reservoir flood limited water level considering forecast uncertainty is disclosed. The flood forecast feasibility of a reservoir controlled basin is analyzed, and the principle of maximum entropy is adopted to identify forecast error distribution; A framework of operation rules for lowering the flood limited water level at the flood rising stage is formulated by using an idea of pre-release, and the forecast operation framework is optimized to obtain forecast operation solution optimization point sets; All optimization point sets that achieve the upstream and downstream flood control safety in case of maximum forecast errors are screened out from the forecast operation solution optimization point sets; and finally, in comprehensive consideration of forecast errors and different preferences of decision makers, the optimal forecast operation solution points are evaluated by using a binary comparison method and a fuzzy optimization model.

### TECHNICAL FIELD

The present invention belongs to the technical field of reservoir flood control operation considering forecasts, and relates to a flood control forecast operation method for lowering the reservoir flood limited water level considering forecast uncertainty.

### BACKGROUND

With the continuous advancement of the information age and the continuous improvement of flood forecast accuracy and forecast period, the flood control forecast operation of reservoirs is extensively developed (Dalian University of Technology, Office of State Flood Control and Drought Relief Headquarters, Reservoir Flood Control Forecast Operation Method and Application [M], China Water & Power Press, 1996: 1-6). According to different regulation methods of the flood limited water level, the methods for reservoir flood control operation considering forecasts can be mainly divided into a method for reservoir flood control operation considering forecasts for raising the flood limited water level with the purpose of increasing utilizable benefits and a method for reservoir flood control operation considering forecasts for lowering the flood limited water level with the purpose of increasing flood control benefits. At present, the former has been widely used in large-scale reservoirs with good regulation performance in northern areas seriously short of water (Yuan Jingxuan, Wang Bende, Tian Li. Research of Flood Control Operation Mode Based on Forecast Information and Risk Analysis for Baiguishan Reservoir [J]. Journal of Hydroelectric Engineering, 2010, 29(02): 132-138), and the research on the latter is relatively less. However, flood control is always the first task of the reservoir. Therefore, how to maximize the flood control benefits of the reservoir while ensuring the original conservation benefits during the flood season is the most concerned issue for reservoir management decision-makers.

In addition, flood forecasts, as a prerequisite for reservoir flood control operation considering forecasts, plays an important role in maximizing benefits of reservoirs. However, in the process of flood forecasts, the forecast model, input, output have uncertainties, which causes forecast errors in flood (Diao Yanfang, Wang Bende, Liu Ji, Study on Distribution of Flood Forecasting Errors by the Method Based on Maximum Entropy [J]. Journal of Hydraulic Engineering. 2007(05): 591-595.), and the forecast errors have direct influence on operation decisions. When the forecast streamflow into a reservoir is small, the release streamflow of the reservoir will be small, and the reservoir level will rise, which may increase the flood control risk of the reservoir; and when the forecast streamflow into a reservoir is large, the release streamflow of the reservoir will be large, which may increase the flood control risk of downstream protection points. Therefore, how to formulate a reasonable forecast operation method considering the forecast information with uncertainty is difficult. The previous studies only consider the maximum forecast error to determine flood control operation rules considering forecast with the goal of maximizing comprehensive benefits, and with the constraint of achieving the upstream and downstream flood control safety under the condition of the extreme errors (Zhou Rurui, Study on Flood Control Operation Mode and Risk Analysis for Parallel Reservoir Groups [D]. Dalian University of Technology, 2017.; Zhang Jing. Reservoir Flood Control Classified Forecast Dispatching Mode and Risk Analysis [D]. Dalian University of Technology, 2008.). However, the distribution of forecast errors shows that the probability of the extreme errors in forecasts is relatively small, and the solution that maximizes the benefits of the reservoirs under the condition of the extreme errors does not necessarily have the optimal operation effect under the condition of other errors. Therefore, the present invention proposes a new flood control forecast operation method for lowering the reservoir flood limited water level considering forecast error distribution.

### SUMMARY

In view of the defects in the prior art, the present invention provides a flood control forecast operation method for lowering the reservoir flood limited water level considering forecast uncertainty.

The present invention adopts the following technical solution:

A forecast operation method for lowering the reservoir flood limited water level considering forecast uncertainty, with the flow chart shown in FIG. 1, mainly comprises the following steps:

Step 1: respectively analyzing the availabilities of the flood forecast information for a reservoir controlled basin and the interval basin between the reservoir and the downstream protection object, and determining pre-release evaluation indexes for reservoir flood control operation considering forecasts according to conventional reservoir flood control rules not considering the forecast information.

Step 2: determining a pre-release solution for flood control operation rules considering forecast. In order to effectively use the forecast information and maximize the flood control benefits of the reservoir, the method of the present invention for pre-releasing the reservoir at the flood rising stage to lower the flood limited water level and free up the flood control capacity adopts a pre-release solution at the flood rising stage and a conventional flood control operation solution at the flood regulation stage. The steps are as follows:

First, judging whether future floods will exceed a certain design flood (generally meaning the minimum value of the design floods corresponding to all protection objects of the reservoir) according to the forecast inflow in the upstream of the reservoir and determining whether the reservoir will be pre-released. If the design flood is exceeded, pre-release is required; otherwise, no pre-release is required. The basis for determining the pre-release volume is that “the pre-release value of the reservoir can ensure that after the reservoir is released at the current release volume, the future inflow can make the reservoir level rise to the designed flood limited water level”.

The specific formula for determining the pre-release volume is as follows:

$$\begin{matrix}{Q}_{out} ( t ) = \frac{( V ( t ) + \overline{W} ( t ) - {V}_{flood} )}{Δ t} & ( 1 ) \\ \overline{W} ( t ) = {\sum }_{k = 1}^{T} \overline{Q} ( t + k ) \times Δ t & ( 2 )\end{matrix}$$

and if:

Qₒᵤₜ(t)>Q_{Lim}(t) (3)

then:

Qₒᵤₜ(t)=Q_{Lim}(t) (4)

wherein t represents the current time of the reservoir; V(t) represents the reservoir capacity at the time t; V_{flood} represents the reservoir capacity corresponding to the designed flood limited water level; Q̅(t+k) is the forecast streamflow of the k^{th} day in the future forecast by a flood forecast model in real time at the time t, k=1, 2, . . . , T, and T represents the forecast period; W̅(t) represents the total forecast incoming water in the next T days at the time t; Qₒᵤₜ(t) represents the release streamflow at the time t; Q_{Lim}(t) represents the maximum allowable release streamflow of the reservoir at the time t; and Δt represents the time unit.

When the incoming water of the reservoir is greater than the design flood at the moment, the conventional flood control operation method is adopted for flood regulation.

Step 3: adopting the maximum entropy model to determine a flood volume forecast error distribution function and to determine a forecast error domain.

The present invention uses the maximum entropy model to identify the relative error distribution of the T-day forecast flood volumes. The specific maximum entropy model is as follows:

$$H ( p ) = - {\sum }_{x ∈ X} p ( x ) ln p ( x ) \qquad ( 5 )$$

wherein x represents the relative errors of the T-day forecast flood volumes, X represents a set of the relative errors of the T-day forecast flood volumes, and p(x) represents the probability density function of the relative errors of the T-day forecast flood volumes;

The following constrains are satisfied:

H(p)≤log|x| (6)

Constructing the maximum entropy model representation of the relative errors of the T-day forecast flood volumes. Establishing an objective function as follows:

$$\begin{matrix}Max ( H ( p ) ) = - Max [ {\sum }_{X} p ( x ) ln p ( x ) ] & ( 7 ) \\ s . t . {\sum }_{X} p ( x ) = 1 & ( 8 ) \\ {\sum }_{X} {x}^{k} p ( x ) = E ( {x}^{k} ) & ( 9 )\end{matrix}$$

wherein E(x^{k}) represents the k order origin moment of x; and m represents the order of the origin moment of x.

From the maximum entropy model formulas (5)-(9), the relative error distribution function of T-day forecast flood volumes of the flood forecast model can be obtained. Determining the error δ₀ and the error domain [δₘᵢₙ, δₘₐₓ] with the maximum probability according to the probability distribution function, wherein δₘᵢₙ is the minimum possible error, and δₘₐₓ is the maximum possible error.

Step 4: introducing the error δ₀ with the maximum probability of occurrence into flood control operation, establishing an optimization model for the flood control operation rules considering forecast with the purposes of minimizing the highest water level of the upstream reservoir, minimizing the flood peak flow of the downstream and maximizing the resilience of the downstream protection points and with the evaluation indexes (based on different characteristics of reservoirs, the evaluation indexes are generally water level, streamflow and net rainfall) in the flood control rules as the decision variable of the flood control operation rules considering forecast, and optimizing the model by using the non-dominant genetic algorithm NSGA-II to obtain a set of operation solutions considering forecasts.

The present invention introduces the resilience of downstream protection points into forecast operation as a new target determined by the flood control operation rule considering forecast for the first time (analyzing the characteristics of the protection system during flood damage and adopting the system functionality to describe the response of the downstream protection points to floods to quantify the resilience of downstream protection points). The resilience of downstream protection points is defined as the ability of downstream protection points to resist floods, absorb floods, adapt to floods and restore to the initial state after flood events. The flood process is similar to a downward parabola, as shown in FIG. 2: tₛ represents the time when the flood begins to damage the system; tₑ represents the time when the flood ends damage to the system; t_{fs} represents the time when the flood begins to peak; t_{fe} represents the time when the flood begins to recede after peaking; tₙ represents the time for the system to completely return to normal after the flood, and also can be understood as the duration of the entire process of the system suffering the flood; Qᵢₙᵢₜᵢₐₗ represents the maximum streamflow when the downstream protection points begin to be damaged, i.e., the system will not be damaged when the streamflow of the flood suffered by the downstream protection points is less than this value; and Qₘₐₓ represents the maximum flood peak flow allowed by the downstream protection points, and the system performance is 0 when the streamflow exceeds this value. The system is not damaged by the flood when the streamflow is less than Qᵢₙᵢₜᵢₐₗ; the system is damaged when the streamflow exceeds Qᵢₙᵢₜᵢₐₗ, and the damage to the system increases as the streamflow increases continuously; and the system functions are completely lost when the maximum allowable peak value Qₘₐₓ of the system is reached. The change process of the corresponding system performance is as follows: before the downstream protection system suffers the flood (0˜tₛ), that is, when the outflow rate of the downstream protection points is less than Qᵢₙᵢₜᵢₐₗ, the system is in normal operation, and the system performance value is 1; when the streamflow exceeds Qᵢₙᵢₜᵢₐₗ, the system begins to be damaged and resists and absorbs the flood, and the system performance degrades as the streamflow increases; when the streamflow increases continuously to the flood peak stage (t_{fs}˜t_{fe}), the system begins to adapt to the flood; and then, the flood enters the recession stage (t_{fe}˜tₑ), the system begins to restore, the performance increases with the decrease of the streamflow until the streamflow is less than Qᵢₙᵢₜᵢₐₗ, and the system begins to enter the post-flood self-adaptive regulation stage (tₑ˜tₙ) until the system returns to normal. In FIG. 2, dark gray area indicates the system function loss during the whole process of flood damage, which can also be called the severity S of system function. Light gray area indicates the resilience index R of the system, which is inversely proportional to the severity S of system function. In the present invention, the state value ps(t) of the system function of the downstream protection points at any time t is described in formula (1):

$$ps ( t ) = \{ \begin{matrix}1 & Q ( t ) \leq {Q}_{initial} \\ \frac{{Q}_{max} - Q ( t )}{{Q}_{max} - {Q}_{initial}} & {Q}_{initial} < Q ( t ) < {Q}_{max} \\ 0 & Q ( t ) \geq {Q}_{max}\end{matrix} \qquad ( 10 )$$

wherein it can be known from the above formula that the range of ps(t) is 0-1.

The system severity S is the average degree of damage when the system is damaged, and the calculation formula is as follows:

$$S = \frac{1}{{t}_{n}} {\int }_{0}^{{t}_{n}} [ 1 - ps ( t ) ] dt \qquad ( 11 )$$

wherein tₙ represents the time for the system to completely return to normal after the flood, and also can be understood as the duration of the entire process of the system suffering the flood.

The flood resilience of the system can be obtained by integrating the system functionality curve, which can be expressed as follows:

$$R = \frac{1}{{t}_{n}} {\int }_{0}^{{t}_{n}} ps ( t ) dt \qquad ( 12 )$$

Step 5: substituting the extreme errors [δₘᵢₙ and δₘₐₓ] of the error domain (δₘᵢₙ, δₘₐₓ) into the set of operation solutions considering forecasts obtained in step 4 to regulate the flood, screening out operation solutions considering forecasts which achieve the operation safety, and supposing the number of the solutions is M. Then performing comprehensive evaluation on the M solutions, and screening out the optimal solution.

The screening step is as follows:

5.1) First dividing [δₘᵢₙ, δₘₐₓ] into N−1 equal parts, i.e., [δ(1), δ(2), . . . , δ(N−1), δ(N)] (where δ(0)=δₘᵢₙ and δ(N)=δₘₐₓ), to obtain forecast floods under different errors δ(1), . . . , δ(N−1), δ(N), respectively adopting the M solutions to regulate floods to obtain three target values under different forecast errors: highest water level Zmax of upstream, maximum streamflow Qmax of downstream and flood resilience value R of downstream protection points, and using Z(i,j,l) to represent the l^{th} target value of the i^{th} solution under the j^{th} discrete forecast error, wherein i=1, 2, . . . , M; j=1, N; 1=1, 2, 3; and each solution has N×3 evaluation indexes.

5.2) According to the forecast error distribution in step 3, obtaining the probability of occurrence of each discrete forecast error, i.e., P(1), . . . , P(N−1), P(N). Performing normalization to obtain Pw(1), . . . , Pw(N−1), Pw(N).

5.3) Evaluating each solution by using the fuzzy evaluation method, wherein formula (14) represents the index matrix of all the solutions, it can be known from formula 1) that M solutions exist, each solution has K=N×3 evaluation indexes which are expressed by the index characteristic matrix A, and the specific formula is as follows:

$$A = [ \begin{matrix}A ( 1 , 1 ) & A ( 1 , 2 ) & … & A ( 1 , K ) \\ A ( 2 , 1 ) & A ( 2 , 2 ) & & A ( 2 , K ) \\ & ⋮ & ⋱ & ⋮ \\ A ( M , 1 ) & A ( M , 2 ) & ⋯ & A ( M , K )\end{matrix} ] \qquad ( 14 )$$

wherein A(i,k)=Z(i,j,l); k=(j−1)*3+l; k=1, 2, . . . , N×3; i=1, 2, . . . , M; j=1, 2, . . . , N; and l=1, 2, 3;

5.4) Calculating the relative membership degree of each index in formula (14)
When the index i is the larger, the better, the corresponding relative membership degree R(i,k) is:

$$R ( i , k ) = \frac{A ( i , k ) - min ( A ( : , k ) )}{max ( A ( : , k ) ) - min ( A ( : , k ) )} \qquad ( 14 )$$

When the index i is the smaller, the better, the corresponding relative membership degree R(i,k) is:

$$R ( i , k ) = \frac{max ( A ( : , k ) ) - A ( i , k )}{max ( A ( : , k ) ) - min ( A ( : , k ) )} \qquad ( 15 )$$

wherein max(A(:,k)) represents the maximum value of the k^{th} index of all the solutions; and min(A(:, k)) represents the minimum value of the k^{th} index of all the solutions;

5.5) Using formulas (14) and (15) to calculate the relative membership degree of each index of each solution to form the relative membership degree matrix of the evaluation indexes, as shown in formula (16):

$$R = [ \begin{matrix}R ( 1 , 1 ) & R ( 1 , 2 ) & … & R ( 1 , K ) \\ R ( 2 , 1 ) & R ( 2 , 2 ) & & R ( 2 , K ) \\ ⋮ & & ⋱ & ⋮ \\ R ( M , 1 ) & R ( M , 2 ) & … & R ( M , K )\end{matrix} ] \qquad ( 16 )$$

wherein the relative membership degree value RU(i,j,l) of the l^{th} target under the j^{th} error value corresponding to the i^{th} solution is R(i,k); k=(j−1)*3+l; k=1, 2, . . . , N×3; i=1, 2, . . . , M; j=1, 2, . . . , N; and l=1, 2, 3. This process is equivalent to a process from 2D to 3D, which can be understood as that the relative membership degree R(i,k) of the k^{th} index of the i^{th} solution represents the relative membership degree RU(i,j,l) of the l^{th} target under the j^{th} error value corresponding to the i^{th} solution.

5.6) Using the binary comparison method to determine the weights of the three targets Zmax, Qmax and R in combination with different preferences of decision makers, as shown in formulas (17-20):

E={E₁,E₂,E₃} (17)

wherein E is the target matrix; E₁ represents the target Zmax; E₂ represents the target Qmax; and E₃ represents the target R.

When the qualitative analysis shows that the index Eₗ is more important than Eₕ, the qualitative ranking scale of importance of the l^{th} target relative to the h^{th} target is μ(l,h)=1; conversely, when the qualitative analysis shows that the index Eₕ is less important than Eₗ, the qualitative ranking scale of importance of the h^{th} target relative to the l^{th} target is μ(h,l)=0; and when the index Eₗ is as important as Eₕ, μ(l,h)=0.5 and μ(h,l)=0.5. The qualitative ranking scale of importance among the targets is deduced accordingly to form an importance binary comparison superiority matrix, as shown in formula (18):

$$μ = [ \begin{matrix}μ ( 1 , 1 ) & μ ( 1 , 2 ) & μ ( 1 , 3 ) \\ μ ( 2 , 1 ) & μ ( 2 , 2 ) & μ ( 2 , 3 ) \\ μ ( 3 , 1 ) & μ ( 3 , 2 ) & μ ( 3 , 3 )\end{matrix} ] \qquad ( 18 )$$

After obtaining the binary comparison superiority matrix μ among the targets, superimposing every 1 row(s) to obtain sum(μ(1,:)), as shown in formula (19):

θ=[sum(μ(1,:))sum(μ(2,:))sum(μ(3,:))]^{T} (19)

Then performing normalization to obtain the weight of each target:

ω=[(ω(1)ω(2)ω(3)]^{T} (20)

5.7) Using the fuzzy relative membership degree model to calculate the relative membership degree corresponding to each solution, wherein the calculation formula of the relative membership degree U(i) of the i^{th} solution is as follows:

$$U ( i ) = \frac{1}{1 + {\{ \frac{{{\sum }^{3}}_{l = 1} {{\sum }^{N}}_{j = 1} {[ ω ( l ) P w ( j ) ( R U ( i , j , l ) - 1 ) ]}^{λ}}{{{\sum }^{3}}_{l = 1} {{\sum }^{N}}_{j = 1} {( ω ( l ) Pw ( j ) R U ( i , j , l ) )}^{λ}} \}}^{\frac{2}{λ}}} \qquad ( 21 )$$

wherein ω(l) represents the weight of l^{th} target. Pw(j) represents the result obtained by normalizing P(j), and P(j) represents the probability of occurrence of the j^{th} discrete forecast error. The larger U(i) is, the higher the degree of satisfaction with the decision is; λ is a distance parameter, and when λ=1, indicating a solving model, the Hamming distance is adopted; and when λ=2, indicating a solving model, the Euclidean distance is adopted. The present invention adopts λ=1.

5.8) Selecting the solution with the maximum relative membership degree as the final solution.

Compared with the prior art, the present invention has the following advantages and effects:

The present invention increases the flood control benefit of the reservoir by lowering the reservoir flood limited water level, introduces the error with the maximum probability of occurrence of flood forecasts into the optimization of the flood control operation rules considering forecast, and optimizes the operation solution in consideration of the forecast error distribution, and the flood control benefits of the recommended forecast operation solution is higher than those of the operation solution not considering forecast operation. In addition, the present invention introduces the resilience of downstream protection points into forecast operation for the first time, and increases the flood control benefits of the reservoir and the resilience of downstream protection points are increased in the premise of not reducing the utilizable benefits.

### DESCRIPTION OF DRAWINGS

FIG. 1 is a flow chart for determining rules for reservoir flood control operation considering forecasts for lowering the flood limited water level considering forecast errors.

FIG. 2 is a system functional diagram of downstream protection points in operation of a reservoir.

FIG. 3 is a comparison diagram of optimization point sets of three targets considering forecasts and not considering forecasts.

FIG. 4 shows a probability curve of relative errors of 4-day forecast flood volumes of a flood forecast model.

FIG. 5 is a comparison diagram of optimization point sets of three targets considering forecasts and not considering forecasts; Fig. (a) and Fig. (b) are projection drawings from different angles (in the figures, the gray dot CNF represents optimization points of three targets not considering forecasts; the inverted triangle CF represents optimization points of three targets considering forecasts; and the black diamond CS represents floor regulation result points of conventional operation).

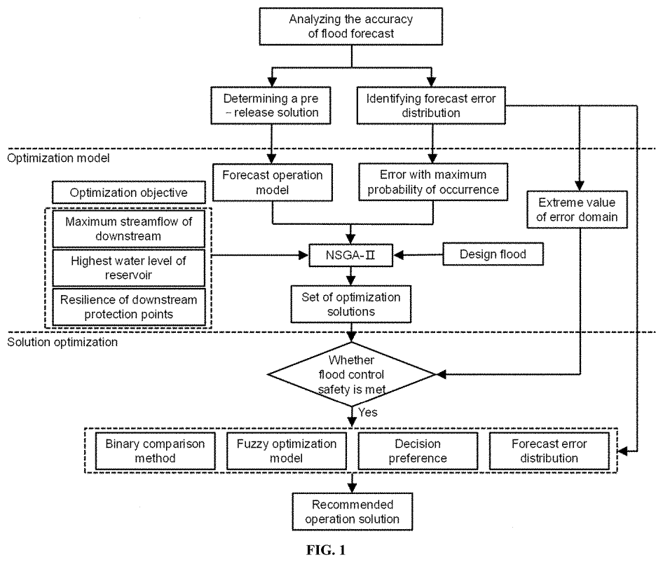

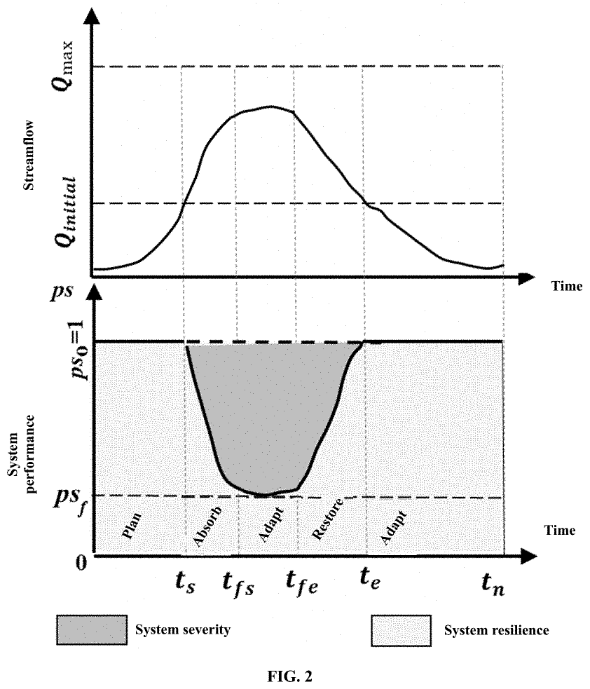

### DETAILED DESCRIPTION

The method for determining rules for reservoir flood control operation considering forecasts for lowering the reservoir flood limited water level considering flood forecast errors proposed by the present invention is mainly divided into two parts: designing a pre-release solution for lowering the flood limited water level and optimizing operation rules considering forecast error distribution. With the Nierji reservoir as an example, specific embodiments of the present invention are described in detail in combination with the technical solution and accompanying drawings. The method comprises the following specific steps:

Step 1: determining pre-release evaluation indexes for reservoir flood control operation considering forecasts based on the flood forecast solution for an area between the reservoir controlled basin and the downstream.

To increase the flood control benefits of the Nierji reservoir, the present invention first analyzes the accuracy of hydrolgocial forecasts for the upstream basin of the Nierji reservoir and the basin of an area between the Nierji reservoir and Qiqihar, and determines the forecast operation evaluation index as the total forecast flood volumes for 4 days.

Step 2: determining a pre-release solution for flood control operation rules considering forecast. In order to effectively use the forecast information and maximize the flood control benefits of the reservoir, the present invention proposes a method for pre-releasing the reservoir at the flood rising stage to lower the flood limited water level and free up the flood control capacity, that is to adopt a pre-release solution at the flood rising stage, and to adopt a convention flood control operation solution at the flood regulation stage.

The main basis for the pre-release volume is that “the pre-release value of the reservoir can ensure that after the reservoir is released at the current release volume, the total volume of the future coming water can make the reservoir return to the original flood limited water level (213.37 m)”. In order to ensure the flood control safety in the event of a major flood, if the flood occurs once in more than 20 years, the conventional operation method (that is not considering forecasts) is used for operation. Therefore, the pre-release operation solution for the early flood season is as follows; when the flood occurs once in less than 20 years, the reservoir is pre-released under the condition of ensuring that the forecast coming water in the next 4 days can make the reservoir level return to the normal flood limited water level of 213.37 m, and the release streamflow and the combined streamflow of Guchengzi and Dedu are required to be less than that occurring once in less than 20 years. The specific formula for pre-release is shown in formulas (1-4). When the flood occurs once in more than 20 years, the flood control operation rules are adopted for flood regulation. The flood control operation rules considering forecast are shown in Table 1, and X in Table 1 is an optimization variable.

TABLE 1
Framework of Rules of Reservoir Flood Control Operation
Considering Forecasts of Nierji Reservoir

| | | | | Release Control Method | |
|---|---|---|---|---|---|
| Adverse | Water Level | | | Flood | Flood |
| Flood | Evaluation | | | Detention | Release |
| Type | Index | Streamflow Evaluation Index | | Stage | Stage |
| \textcircled{1} | Z < 218.15 m | Q_{combined} ≤ LimQ₁ | Qᵢₙ ≤ 2000 m³/s | Qᵢₙ | |
| | | | Qᵢₙ > 2000 m³/s | Qₒᵤₜ (t) | |
| | | LimQ₁ m³/s ≤ Q_{combined} ≤ LimQ₂ m³/s | | X₂ | X₃ |
| | | LimQ₂ m³/s ≤ Q_{combined} ≤ LimQ₃ m³/s | | X₄ | X₅ |
| | | Q_{combined} ≥ LimQ₃ m³/s | | | |
| | Z ≥ 218.15 m | | | X₆ | X₇ |

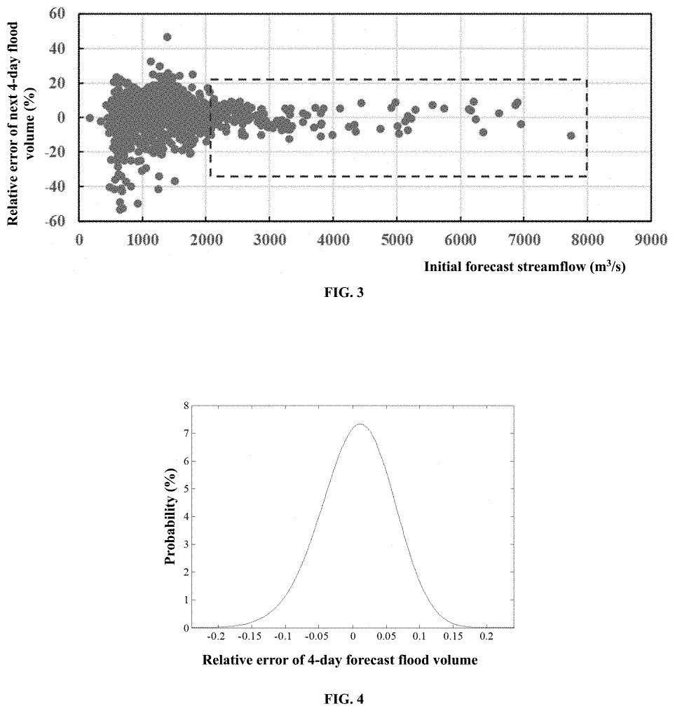

Step 3: adopting the maximum entropy model, i.e., formulas (5-9), to determine a flood volume forecast error distribution function (as shown in FIG. 3-4) and to determine a forecast error domain. From the maximum entropy model, the relative error probability curve of 4-day forecast flood volumes of the flood forecast model can be obtained, as shown in FIG. 4. It can be known that the error δ₀ with the maximum probability of occurrence is 1.3%, and the probability of the relative errors of 4-day forecast flood volumes beyond [−22%, 19%] is 0.01%, so the error domain determined in this chapter is [−22%, 19%].

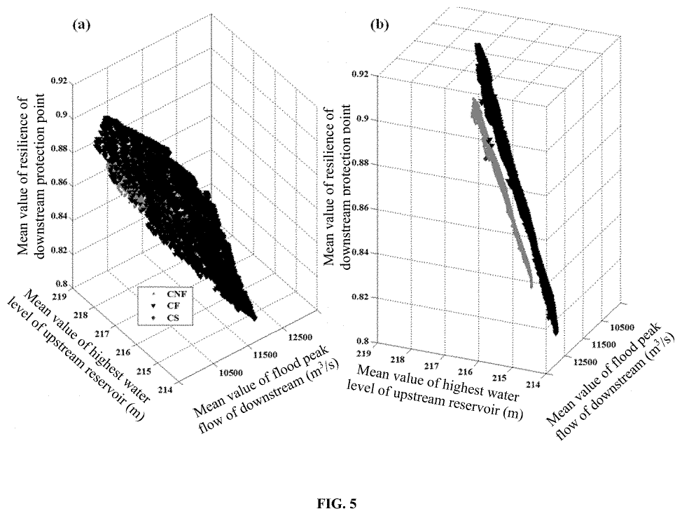

Step 4, introducing the error δ₀=1.3% with the maximum probability of occurrence into the flood control forecast operation model, and establishing an optimization model for the flood control operation rules considering forecast with the purposes of minimizing the highest water level of the Nierji reservoir, minimizing the flood peak flow of Qiqihar in the downstream and maximizing the resilience of the downstream protection points of Qiqihar in the downstream (see formulas (10-12)). The non-dominant genetic algorithm NSGA-II is adopted for multi-target optimization to obtain a set of operation solutions considering forecasts, as shown in FIG. 5, wherein in the setting of the downstream protection points, Qᵢₙᵢₜᵢₐₗ and Qₘₐₓ are respectively 6580 m³/s (the minimum standard of Qiqihar for downstream protection points of Nierji reservoir) and 12000 m³/s (the flood occurring once in 100 years in Qiqihar for downstream protection points of Nierji reservoir).

Step 5: respectively substituting the extreme errors (−22% and 19%) of the error domain [−22%, 19%] into the set of operation solutions considering forecasts (10000 groups of solutions) obtained in step 4 to regulate the flood, and screening out operation solutions considering forecasts which achieve the operation safety, wherein the number of operation solutions considering forecasts is M=1661. Then screening the M solutions.

First dividing the error [−22%, 19%] into 410 equal parts, [−22%, −21.9%, . . . , 1.2%, 1.3%, . . . , 18.9%, 19%], respectively substituting δ(1), . . . , δ(N−1), δ(N) into 1661 solutions to obtain target values under different forecast errors: highest water level Zmax of upstream, maximum streamflow Qmax of downstream and flood resilience value R of downstream protection points, and using Z(i,j,l) to represent the l^{th} target value of the i^{th} solution under the j^{th} discrete forecast error, wherein i=1, 2, . . . , M; j=1, N; 1=1, 2, 3; and each solution has 411×3 evaluation indexes. In combination with different preferences of decision makers, i.e., upstream safety (Zmax)=downstream safety (Qmax) (ignoring resilience R of downstream protection points), upstream safety (Zmax)=downstream safety (Qmax)=resilience (R) of downstream protection points, upstream safety (Zmax)>downstream safety (Qmax)>resilience (R) of downstream protection points, and downstream safety (Qmax)>upstream safety (Zmax)>resilience (R) of downstream protection points, using the binary comparison method and the fuzzy optimization model to evaluate the set of forecast operation solutions, i.e., formulas (14-21), to give a recommended forecast operation solution CBF, as shown in Table 2.

TABLE 1
Comparison of Overall Evaluation Indexes of Solutions

| | Relative error of forecast | | | Relative error of forecast | | | Relative error of forecast | | |
|---|---|---|---|---|---|---|---|---|---|
| | −22% | | | −0.2% | | | +20% | | |
| | Zmax | Qmax | R | Zmax | Qmax | R | Zmax | Qmax | R |
| Solution Z | 216.95 | 10380 | 85.14% | 216.57 | 10400 | 84.96% | 216.08 | 10480 | 84.82% |
| Solution Q | 218.01 | 9810 | 88.46% | 217.92 | 9620 | 89.13% | 217.75 | 9630 | 90.00% |
| Solution QZR | 218.06 | 9760 | 88.75% | 217.98 | 9600 | 89.41% | 217.88 | 9630 | 90.35% |
| Solution QZ | 217.09 | 10280 | 85.65% | 216.70 | 10320 | 85.47% | 216.19 | 10410 | 85.18% |
| Solution CBF | 217.80 | 9920 | 88.49% | 217.52 | 9940 | 88.48% | 217.20 | 10020 | 88.54% |
| Solution CB | 217.53 | 10190 | 86.87% | 217.53 | 10190 | 86.87% | 217.53 | 10190 | 86.87% |

The present invention proposes a forecast operation method for lowering the reservoir flood limited water level considering forecast uncertainty on the basis of ensuring that the future inflow can make the reservoir return to the designed flood limited water level, which is simple and easy to operate and increases the flood control benefit of the reservoir and the resilience of the flood downstream protection points under the action of floods while maintaining the utilizable benefits.

The above embodiments only express the implementation of the present invention, and shall not be interpreted as a limitation to the scope of the patent for the present invention. It should be noted that, for those skilled in the art, several variations and improvements can also be made without departing from the concept of the present invention, all of which belong to the protection scope of the present invention.

1. A forecast operation method for lowering the reservoir flood limited water level considering forecast uncertainty, wherein the method comprises the following steps:
step 1: respectively analyzing the availabilities of the flood forecast information for a reservoir controlled basin and the interval basin between the reservoir and the downstream protection object, and determining pre-release evaluation indexes for reservoir flood control operation considering forecasts according to conventional reservoir flood control rules not considering the forecast information;
step 2: determining a pre-release solution for flood control operation rules considering forecast according to the forecast information;
pre-releasing the reservoir at the flood rising stage to lower the flood limited water level, wherein the pre-release solution is to adopt a pre-release solution at the flood rising stage and to adopt a conventional flood control operation solution at the flood regulation stage, specifically:
judging whether future floods will exceed a certain design flood according to the forecast coming water in the upstream of the reservoir and determining whether the reservoir will be pre-released, wherein the design flood means the minimum value of the design floods corresponding to all protection objects of the reservoir; if the design flood is exceeded, pre-release is required; otherwise, no pre-release is required; the basis for determining the pre-release volume is that “the pre-release value of the reservoir can ensure that after the reservoir is released at the current release volume, the future coming water can make the reservoir level rise to the designed flood limited water level”; and when the incoming water of the reservoir is greater than the design flood at the moment, entering the flood regulation stage and adopting the conventional flood control operation method;
the specific formula for determining the pre-release volume is as follows:
$$\begin{matrix}{Q}_{o u t} ( t ) = \frac{( V ( t ) + \overline{W} ( t ) - {V}_{f l o o d} )}{Δt} & ( 1 ) \\ \overline{W} ( t ) = {\sum }_{k = 1}^{T} \overline{Q} ( t + k ) \times Δt & ( 2 )\end{matrix}$$
and if:
Qₒᵤₜ(t)>Q_{Lim}(t) (3)
then:
Qₒᵤₜ(t)=Q_{Lim}(t)
wherein t represents the current time of the reservoir; V(t) represents the reservoir capacity at the time t; V_{flood} represents the reservoir capacity corresponding to the designed flood limited water level; Q̅(t+k) is the forecast streamflow of the k^{th} day in the future forecast by a flood forecast model in real time at the time t, k=1, 2, . . . , T, and T represents the forecast period; W̅(t) represents the total forecast incoming water in the next T days at the time t; Qₒᵤₜ(t) represents the release streamflow at the time t; Q_{Lim}(t) represents the maximum allowable release streamflow of the reservoir at the time t; and Δt represents the time unit;
step 3: adopting the maximum entropy model to identify the relative error distribution of T-day forecast flood volumes to determine the relative error distribution function of T-day forecast flood volumes of the flood forecast model; and determining the error δ₀ and the forecast error domain [δₘᵢₙ, δₘₐₓ] with the maximum probability according to the relative error distribution function, wherein δₘᵢₙ is the minimum possible error, and δₘₐₓ is the maximum possible error;
step 4: introducing the error δ₀ with the maximum probability of occurrence into flood control operation, establishing an optimization model for the flood control operation rules considering forecast with the purposes of minimizing the highest water level of the upstream reservoir, minimizing the flood peak flow of the downstream and maximizing the resilience of the downstream protection points and with the evaluation indexes in the flood control rules as the decision variable of the flood control operation rules considering forecast, and optimizing the model by using the non-dominant genetic algorithm NSGA-II to obtain a set of operation solutions considering forecasts;
the resilience of downstream protection points is specifically that: the resilience of downstream protection points is introduced into forecast operation as a new target determined by the flood control operation rule considering forecast for the first time; the resilience of downstream protection points is defined as the ability of downstream protection points to resist floods, absorb floods, adapt to floods and restore to the initial state after flood events; and the state value ps(t) of the system function of the downstream protection points at any time t is described in formula (1):
$$ps ( t ) = \{ \begin{matrix}1 & Q ( t ) \leq {Q}_{i nitial} \\ \frac{{Q}_{max} - Q ( t )}{{Q}_{max} - {Q}_{i nitial}} & {Q}_{i nitial} < Q ( t ) < {Q}_{max} \\ 0 & Q ( t ) \geq {Q}_{max}\end{matrix} \qquad ( 10 )$$
wherein Q(t) represents the flood flow of the downstream protection points at the time t; Qₘₐₓ represents the maximum flood peak flow allowed by the downstream protection points, and the system performance is 0 when the streamflow exceeds this value; and Qᵢₙᵢₜᵢₐₗ represents the maximum streamflow when the downstream protection points begin to be damaged, the system is not damaged when the streamflow is less than Qᵢₙᵢₜᵢₐₗ, the system is damaged when the streamflow exceeds Qᵢₙᵢₜᵢₐₗ, the damage to the system increases as the streamflow increases continuously, and the system functions are completely lost when the maximum allowable peak value Qₘₐₓ of the system is reached;
it can be known from the above formula that the range of ps(t) is 0-1;
the system severity S is the average degree of damage when the system is damaged, and the calculation formula is as follows:
$$S = \frac{1}{{r}_{n}} {\int }_{0}^{{t}_{n}} [ 1 - p s ( t ) ] d t \qquad ( 11 )$$
wherein tₙ represents the time for the system to completely return to normal after the flood, and also can be understood as the duration of the entire process of the system suffering the flood;
the flood resilience of the system can be obtained by integrating the system functionality curve, which is expressed as follows:
$$R = \frac{1}{{r}_{n}} {\int }_{0}^{{t}_{n}} dt \qquad ( 12 )$$
step 5: substituting the extreme errors [δₘᵢₙ and δₘₐₓ] of the error domain (δₘᵢₙ, δₘₐₓ) into the set of operation solutions considering forecasts obtained in step 4 to regulate the flood, screening out operation solutions considering forecasts which achieve the operation safety, and supposing the number of the solutions is M; and then performing comprehensive evaluation on the M solutions, and screening out the optimal solution;
the screening step is as follows:
5.1) first dividing [δₘᵢₙ, δₘₐₓ] into N−1 equal parts, i.e., [δ(1), δ(2), . . . , δ(N−1), δ(N)] (where δ(0)=δₘᵢₙ, δ(N)=δₘₐₓ), to obtain forecast floods under different errors δ(1), . . . , δ(N−1), δ(N), respectively adopting the M solutions to regulate floods to obtain three target values under different forecast errors: highest water level Zmax of upstream, maximum streamflow Qmax of downstream and flood resilience value R of downstream protection points, and using Z(i,j,l) to represent the l^{th} target value of the i^{th} solution under the j^{th} discrete forecast error, wherein i=1, 2, . . . , M; j=1, N; l=1, 2, 3; and each solution has N×3 evaluation indexes;
5.2) according to the forecast error distribution in step 3, obtaining the probability of occurrence of each discrete forecast error, i.e., P(1), . . . , P(N−1), P(N); and performing normalization to obtain Pw(1), . . . , Pw(N−1), Pw(N);
5.3) evaluating each solution by using the fuzzy evaluation method, wherein formula (14) represents the index matrix of all the solutions, it can be known from formula 5.1) that M solutions exist, each solution has K=N×3 evaluation indexes which are expressed by the index characteristic matrix A, and the specific formula is as follows:
$$A = [ \begin{matrix}A ( 1 , 1 ) & A ( 1 , 2 ) & … & A ( 1 , K ) \\ A ( 2 , 1 ) & A ( 2 , 2 ) & & A ( 2 , K ) \\ ⋮ & & ⋱ & ⋮ \\ A ( M , 1 ) & A ( M , 2 ) & … & A ( M , K )\end{matrix} ] \qquad ( 14 )$$
wherein A(i,k)=Z(i,j,l); k=(j−1)*3+l; k=1, 2, . . . , N×3; i=1, 2, . . . , M; j=1, 2, . . . , N; and l=1, 2, 3;
5.4) calculating the relative membership degree of each index in formula (14);
when the index i is the larger, the better, the corresponding relative membership degree R(i,k) is:
$$R ( i , k ) = \frac{A ( i , k ) - min ( A ( : , k ) )}{max ( A ( : , k ) ) - min ( A ( : , k ) )} \qquad ( 14 )$$
when the index i is the smaller, the better, the corresponding relative membership degree R(i,k) is:
$$R ( i , k ) = \frac{max ( A ( : , k ) ) - A ( i , k )}{max ( A ( : , k ) ) - min ( A ( : , k ) )} \qquad ( 15 )$$
wherein max(A(:,k)) represents the maximum value of the k^{th} index of all the solutions; and min(A(:, k)) represents the minimum value of the k^{th} index of all the solutions;
5.5) using formulas (14) and (15) to calculate the relative membership degree of each index of each solution to form the relative membership degree matrix of the evaluation indexes, as shown in formula (16):
$$R = [ \begin{matrix}R ( 1 , 1 ) & R ( 1 , 2 ) & … & R ( 1 , K ) \\ R ( 2 , 1 ) & R ( 2 , 2 ) & & R ( 2 , K ) \\ ⋮ & & ⋱ & ⋮ \\ R ( M , 1 ) & R ( M , 2 ) & … & R ( M , K )\end{matrix} ] \qquad ( 16 )$$
wherein the relative membership degree value RU(i,j,l) of the l^{th} target under the j^{th} error value corresponding to the i^{th} solution is R(i,k); k=(j−1)*3+l; k=1, 2, . . . , N×3; i=1, 2, . . . , M; j=1, 2, . . . , N; and l=1, 2, 3;
5.6) using the binary comparison method to determine the weights of the three targets Zmax, Qmax and R in combination with different preferences of decision makers;
5.7) using the fuzzy relative membership degree model to calculate the relative membership degree corresponding to each solution, and selecting the solution with the maximum relative membership degree as the final solution.

2. The forecast operation method for lowering the reservoir flood limited water level considering forecast errors according to claim 1, wherein the maximum entropy model in step 3 is as follows:
$$H ( p ) = - {\sum }_{x ∈ X} p ( x ) ln p ( x ) \qquad ( 5 )$$
wherein x represents the relative errors of the T-day forecast flood volumes, X represents a set of the relative errors of the T-day forecast flood volumes, and p(x) represents the probability density function of the relative errors of the T-day forecast flood volumes;
the following constrains are satisfied:
H(p)≤log|x| (6)
constructing the maximum entropy model representation of the relative errors of the T-day forecast flood volumes; and establishing an objective function as follows:
$$\begin{matrix}Max ( H ( p ) ) = - Max [ {\sum }_{X} p ( x ) ln p ( x ) ] & ( 7 ) \\ s . t . {\sum }_{X} p ( x ) = 1 & ( 8 ) \\ {\sum }_{X} {x}^{k} p ( x ) = E ( {x}^{k} ) & ( 9 )\end{matrix}$$
wherein E(x^{k}) represents the k order origin moment of x; and m represents the order of the origin moment of x;
obtaining the relative error distribution function of T-day forecast flood volumes of the flood forecast model from the maximum entropy model formulas (5)-(9), and determining the error δ₀ and the error domain [δₘᵢₙ, δₘₐₓ] with the maximum probability according to the probability distribution function.
